(19) United States
(12) Patent Application Publication
(10) Pub. No.: US 2012/0051813 A1
(43) Pub. Date: Mar. 1, 2012

(54) IMAGE FORMING APPARATUS

(75) Inventor: Yoichi Furuyama, Toride-shi (JP)

(73) Assignee: CANON KABUSHIKI KAISHA, Tokyo (JP)

(21) Appl. No.: 13/215,387

(22) Filed: Aug. 23, 2011

(30) Foreign Application Priority Data
Aug. 27, 2010 (JP) 2010-191250

(51) Int. Cl. G03G 15/20

(52) U.S. Cl. 399/341

(57) ABSTRACT

Provided is an image forming apparatus capable of efficiently cooling a hot sheet heated by heat-fixing without causing power consumption or noise. A pair of cooling rollers 200 is disposed at the downstream of fixing device 100 in a sheet conveying direction, in which the pair of cooling rollers includes a cooling roller 201 and a driven roller 203 to convey a sheet P. In addition, a phase-change material 202 is encapsulated in the cooling roller 201, in the temperature of the material to cause a phase-change between solid and liquid is or higher than a standby temperature that is a temperature of the pair of cooling rollers in a standby state, and is lower than a glass transition temperature of toner on the sheet.

### BACKGROUND OF THE INVENTION

1. Field of the Invention

The present invention relates to an image forming apparatus, and particularly, to the image forming apparatus configured to cool a sheet having a toner image fixed thereto by heat.

2. Description of the Related Art

Conventionally, as an image forming apparatus such as a copying machine, a laser beam printer, and a facsimile, there has been known an image forming apparatus which transfers a toner image formed on an image bearing member onto a sheet and heats the sheet to fix the toner image thereto. Then, when the image fixing is performed in this manner, the sheet having the image formed thereon is discharged onto a sheet discharging tray. Here, the heat-fixing temperature varies depending on the type of toners, but is generally about 170° C. Since the fixing heat remains on the sheet even after the sheet is discharged from a heat-fixing device, the temperature of the discharged sheet varies depending on the type of apparatuses, but is about 80° C. at maximum.

When the hot sheet is discharged, the toner on the sheet, wax contained in the toner to assist fixation and separation, oil coated on the surface of a fixing roller, and the like cause adhesion to the sheet. When a copy operation is repeated in such a state, the next sheet is discharged while the toner, the oil, or the wax on the sheet is not sufficiently cooled, which may result in so-called adhering of discharged sheets in which the sheets adhere to each other.

Therefore, in the past, in order to solve such issues, there was known a configuration in which a pair of cooling rollers was provided downstream of a fixing device in the sheet conveying direction to cool a sheet and the cooling rollers were cooled by air blown from a fan (refer to Japanese Patent Laid-Open No. 6-75490). Further, there was known a configuration in which a pair of rotatable heat pipes was provided downstream of a fixing device, a sheet was conveyed to the heat pipes to absorb heat from the sheet, and the absorbed heat radiates from a fin at the end thereof (refer to Japanese Patent Laid-Open No. 10-207155).

Incidentally, in these existing image forming apparatuses, when the cooling rollers are cooled by the fan, the cooling rollers are easily overheated, so that power consumption for operating the cooling fan increases. Further, operation noise such as wind noise is generated during the operation of the fan, which becomes an issue to be solved. Furthermore, when the continuous operation is performed, the air inside the apparatus is warmed by the heat radiated from the fixing device, so that external air as cooling air needs to be introduced thereinto. For this reason, a component such as a duct forming a wind path is needed, and a large space for a duct or a fan is needed.

On the other hand, in the configuration in which the heat pipes are provided to cool the sheet, when the temperature inside the apparatus becomes hot due to the continuous operation or the like, the radiation of the heat is not efficiently achieved by the fin provided at the end, and the temperature of the heat pipes increases, so that the sheet is not likely to be completely cooled. Further, when a configuration is adopted in which the fin is cooled by the fan, power consumption or noise increases due to the fan and the space or the number of components such as a duct increases. Further, since the heat pipe is expensive, the configuration also is problematic in terms of cost.

Therefore, the present invention provides an image forming apparatus capable of reducing power consumption or noise and efficiently cooling a hot sheet heated by heat-fixing.

### SUMMARY OF THE INVENTION

The present invention provides an image forming apparatus including a fixing portion that fixes a toner image on a sheet by heat, a cooling roller that is provided downstream of the fixing portion in a sheet conveying direction and cools the sheet conveyed from the fixing portion, and a phase-change material that is encapsulated in the cooling roller and has a phase-change temperature to cause a phase-change between solid and liquid being higher than a temperature inside the apparatus in a standby state, and being lower than a glass transition temperature of the toner on the sheet.

Like the invention, when the phase-change material is encapsulated in the cooling roller provided downstream of the fixing device in the sheet conveying direction, it is possible to reduce power consumption or noise and efficiently cool the hot sheet heated by the heat-fixing.

Further features of the present invention will become apparent from the following description of exemplary embodiments with reference to the attached drawings.

### BRIEF DESCRIPTION OF THE DRAWINGS

FIG. 1 is a diagram schematically illustrating a configuration of a color image forming apparatus which is an example of an image forming apparatus according to a first embodiment of the invention;

FIG. 2 is a diagram illustrating a fixing device and a pair of cooling rollers of the color image forming apparatus;

FIG. 3 is a diagram illustrating a change in temperature of a phase-change material encapsulated in a cooling roller of the pair of cooling rollers;

FIGS. 4A and 4B are cross-sectional views illustrating the cooling roller;

FIG. 5 is a diagram illustrating a change in temperature of the phase-change material;

FIG. 6 is a diagram illustrating a change in temperature of the phase-change material during a repeated operation;

FIG. 7 is a diagram illustrating a configuration of a pair of cooling rollers of an image forming apparatus according to a second embodiment of the invention;

FIG. 8 is a control block diagram illustrating the image forming apparatus;

FIG. 9 is a diagram illustrating a change in temperature of the phase-change material; and

FIG. 10 is a flowchart illustrating a control of a cooling operation of cooling a cooling roller of the image forming apparatus.

### DESCRIPTION OF THE EMBODIMENTS

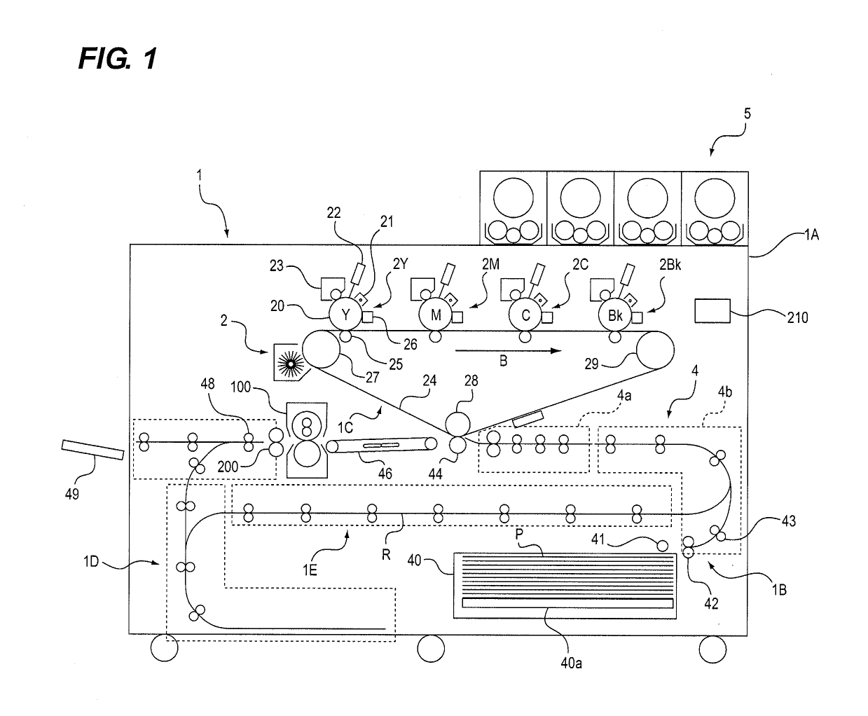

Hereinafter, exemplary embodiments of the invention will be specifically described by referring to the accompanying drawings. FIG. 1 is a diagram schematically illustrating a configuration of a color image forming apparatus which is an example of an image forming apparatus according to a first embodiment of the invention. In FIG. 1, a color image forming apparatus 1 and a color image forming apparatus body 1A (hereinafter, referred to as an apparatus body) are illustrated. The apparatus body 1A includes an image forming portion 2, a sheet feeding portion 1B that feeds a sheet P, and a transfer portion 1C that transfers a toner image formed by the image forming portion 2 onto the sheet P fed by the sheet feeding portion 1B.

Furthermore, in FIG. 1, a sheet conveying device 4 is configured to convey the sheet P fed by the sheet feeding portion 1B to the transfer portion 1C. Then, the sheet conveying device 4 includes a resist unit 4a that is a skew feeding correction device performing skew feeding correction or timing correction of the sheet P and a conveying roller portion 4b that conveys the sheet P to the resist unit 4a.

Here, the image forming portion 2 includes four image forming units 2Y, 2M, 2C, and 2Bk of yellow (Y), magenta (M), cyan (C), and black (Bk). Furthermore, each of the image forming units 2Y, 2M, 2C, and 2Bk includes a photosensitive drum 20 that is an image bearing member, a charging device 21 that evenly charges the surface of the photosensitive drum, and an exposure device 22 that forms an electrostatic latent image on the charged photosensitive drum 20.

Furthermore, each of the image forming units 2Y, 2M, 2C, and 2Bk includes a development device 23 that develops the electrostatic latent image on the photosensitive drum as a toner image using toner having a particle diameter of 5 to 10 μm and a primary transfer roller 25 that transfers the toner image on the photosensitive drum onto an intermediate transfer belt 24 to be described later. Further, a photosensitive cleaner 26 are provided to remove a residual toner on the photosensitive drum. Furthermore, in FIG. 1, a toner container 5 is used to supplement toner.

That is, the color image forming apparatus 1 of the embodiment is of an intermediate transfer tandem type in which four colors of image forming units 2Y, 2M, 2C, and 2Bk are arranged as the image forming portion 2 on the intermediate transfer belt to be described later. Furthermore, the colors formed by the image forming units 2Y, 2M, 2C, and 2Bk are not limited to the four colors, and the arrangement order is not limited thereto.

The sheet feeding portion 1B includes a sheet cassette 40 that is a sheet storing portion storing the sheet P on a lifter 40a to be stacked thereon and being drawable and a sheet feeding roller 41 that feeds the sheet P stored in the sheet cassette 40. Furthermore, in the embodiment, the sheet feeding portion 1B adopts a configuration in which the sheet is fed by the sheet feeding roller 41, and air feeding may be performed in which the sheet is suctioned by air and is fed.

Further, the transfer portion 10 includes the intermediate transfer belt 24 that is suspended on a driving roller 27, a tension roller 29, and a secondary transfer inner roller 28 and is driven to be conveyed in a direction depicted by an arrow B in the drawing. Here, the intermediate transfer belt 24 is used to transfer the toner image formed on the photosensitive by an electrostatic load bias and a predetermined pressure applied by the primary transfer roller 25. Further, a secondary transfer portion formed by the secondary transfer inner roller 28 and a secondary transfer outer roller 44 substantially facing each other is used to allow an unfixed image to be absorbed and adhered onto the sheet P by applying an electrostatic load bias and a predetermined pressure thereto.

When an image is formed in the color image forming apparatus 1 with such a configuration, the surface of the photosensitive drum 20 is first evenly charged by the charging device 21 in advance. Subsequently, image data is input to a CPU (calculating and controlling portion) 210 provided at a predetermined position inside the apparatus body 1A and is transmitted to the exposure device 22. Then, the exposure device 22 emits light based on a signal of image information transmitted therefrom, and allows the photosensitive drum 20 rotating in a counter-clockwise direction to be irradiated with the light, so that a latent image is formed on the surface of the photosensitive drum.

Next, the development device 23 develops the electrostatic latent image formed on the photosensitive drum 20 in this manner using toner, so that a toner image is formed on the photosensitive drum. Subsequently, the toner image is transferred onto the intermediate transfer belt 24 by an electrostatic load bias and the predetermined pressure applied by the primary transfer roller 25. Furthermore, the residual toner slightly remaining on the photosensitive drum 20 is collected by the photosensitive cleaner 26, and the photosensitive drum waits for the next image formation.

Here, the respective image forming units 2Y, 2M, 2C, and 2Bk of the image forming portion 2 perform the image formation at a timing at which the toner images firstly transferred on the intermediate transfer belt overlap each other. As a result, a full color toner image is finally formed on the intermediate transfer belt 24. Further, the sheet P is conveyed by the sheet feeding roller 41 from the sheet cassette 40, is separated one by one by a pair of separating rollers 42, and then is conveyed to the resist unit 4a through the conveying roller portion 4b.

Then, the skew feeding correction or the timing correction is performed on the sheet P by the resist unit 4a, and the sheet P is conveyed to the secondary transfer portion formed by the secondary transfer inner roller 28 and the secondary transfer outer roller 44 substantially facing each other. Subsequently, the full color toner image is secondly transferred onto the sheet P by applying an electrostatic load bias and a predetermined pressure at the secondary transfer portion.

Next, the sheet P onto which the toner image is secondly transferred is conveyed by a pre-fixing conveying portion 46 to a fixing device 100 that is a fixing portion heat-fixing the toner image formed on the sheet. Then, in the fixing device 100, the toner is melted and fixed onto the sheet P by a predetermined pressure generated from rollers substantially facing each other and heat generated from a heat source such as a heater. Next, the sheet P having the image fixed thereon in this manner is discharged by branching rollers 48 onto a sheet discharging tray 49.

Furthermore, when an image is formed on both faces of the sheet P, the sheet P is switched by a switching member (not illustrated) and is conveyed to a reversing and conveying device 1D. Then, when the sheet P is conveyed to the reversing and conveying device 1D, the front and rear ends of the sheet P are switched by a switch back operation, and the sheet P is conveyed to a re-conveying path R provided in a two-sided conveying device 1E. Subsequently, the sheet P merges with the sheet for the next operation conveyed from the sheet feeding portion 1B to match the timing thereof, and is conveyed to the secondary transfer portion together with the sheet. Since the image forming process is the same as that of the first face, this will not be repeated.

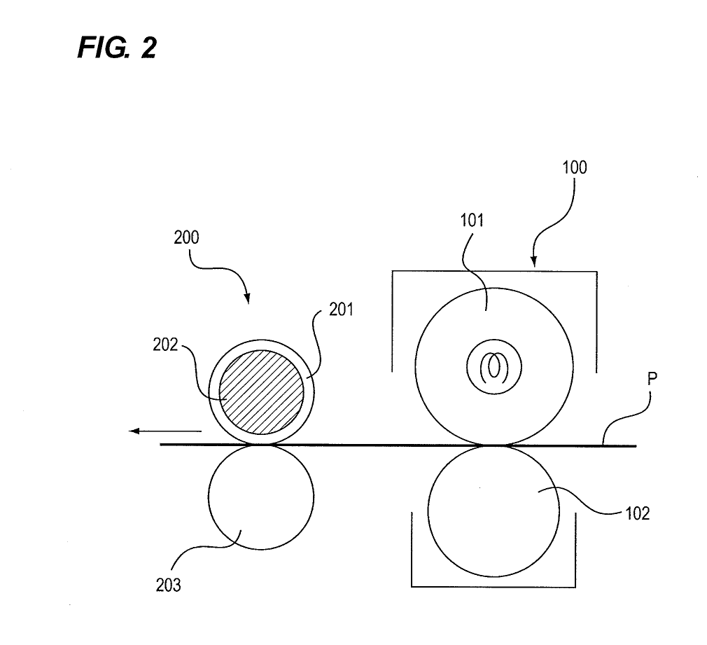

Incidentally, as illustrated in FIG. 2, the fixing device 100 includes a fixing roller 101 and a pressure roller 102, and is configured to fix the toner image onto the sheet by a heat and a pressure. Furthermore, the heat-fixing temperature is different according to the type of toner, but the temperature is about 170° C. Then, since the fixing heat may be accumulated in the sheet, the temperature of the sheet P immediately after passing through the fixing device 100 reaches about 80° C. Here, when sheets are continuously stacked on the sheet discharging tray due to the repeated copy operation, the toner on the sheet may not be sufficiently solidified. In this case, since the sheet has adhesion, there is a possibility of so-called adhering of discharged sheets in which the sheets adhere to each other on the tray. Further, when the hot sheet partially comes into contact with a guide or a rib, a sensor, a conveying roller or the like of a conveying path, irregular gloss may occur on the sheet surface, so that the image quality is degraded.

For this reason, in order to obtain a high quality image, there is a need to provide a device that cools the sheet P and the toner after the fixing. Furthermore, it is desirable that the cooling device evenly cool the sheet and the toner in the width direction so as to prevent an irregular temperature within the surface of the sheet. Therefore, in the embodiment, as the cooling device, a pair of cooling rollers 200 is provided which conveys the sheet to downstream of the fixing device 100 in the sheet conveying direction and cools the sheet. Then, the sheet is evenly cooled in the width direction when the sheet discharged at about 80° C. from the fixing device 100 is nipped and conveyed by the pair of cooling rollers 200.

Here, the pair of cooling rollers 200 includes a cooling roller 201 and a driven roller 203. The cooling roller 201 is formed as a metallic member (for example, aluminum or the like) that has a hollow structure with a diameter of about 20 mm and a width of about 340 mm and has high thermal conductivity. Further, a phase-change material 202 is encapsulated in the cooling roller 201, and has characteristics in which it mainly contains polyethylene glycol (PEG) and a phase-change temperature from solid to liquid is 50° C. Furthermore, the end (not illustrated) of the roller is sealed by a flange member such that the phase-change material is not leaked to the outside of the cooling roller even when the phase-change material is melted and changes into a liquid.

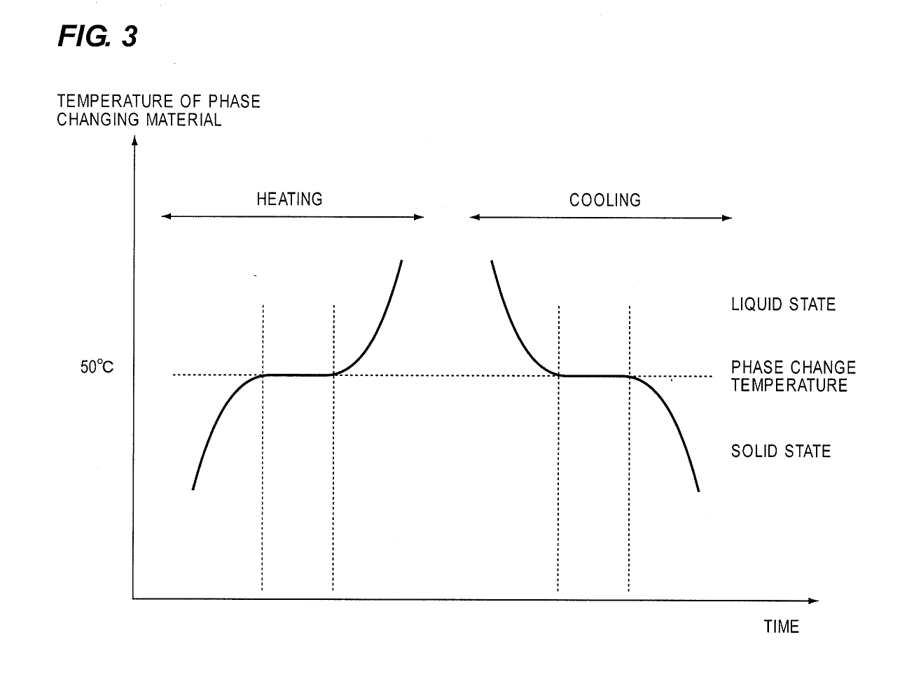

Here, the phase-change material generally indicates a material that is used for cold storage or heat storage, and has a property of maintaining the temperature to be constant by using latent heat generated when the material changes between liquid and solid (absorption of heat in the case of the phase-change from solid to liquid and radiation of heat in the case of the phase-change from liquid to solid). The phase-change material has a change in temperature as illustrated in FIG. 3. That is, when a solid phase-change material is heated, the material is melted at the phase-change temperature and latent heat is absorbed during the melting, so that the temperature is maintained to be constant. On the other hand, when a liquid phase-change material is cooled, the material is solidified at the phase-change temperature and latent heat is radiated during the solidifying, so that the temperature is maintained to be constant.

Furthermore, in the embodiment, a material mainly containing the PED is used as the phase-change material, but the same effect may be obtained even in a material mainly containing paraffin or sodium acetate. Further, the phase-change temperature of the phase-change material may be adjusted according to the composition of the phase-change material. In the embodiment, the phase-change temperature is set to 50° C., but the optimal temperature may be set by designing the composition thereof according to the specification of the apparatus. The condition of satisfying the phase-change temperature is from the temperature of the cooling roller 201 (a standby-temperature as an ambient temperature inside the apparatus) in a standby state of the apparatus to the upper limit temperature of the cooling roller 201 at which the sheet passing through the cooling roller 201 does not cause adhering of discharged sheets.

Furthermore, in order to prevent the adhering of discharged sheets, the temperature of the cooling roller 201 needs to be maintained at a temperature lower than the glass transition temperature of the toner so as to solidify all toner on the sheet passing through the cooling roller 201. The glass transition temperature indicates a temperature at which the toner starts to be softened, and is different according to the type of toner. Further, since the gloss amount (surface property) of the sheet passing through the cooling roller 201 changes so that the time to solidify all toner on the sheet changes due to the temperature of the cooling roller 201, it is desirable that the phase-change temperature be set to obtain a desired gloss amount.

Here, when a continuous operation repeating a copy operation is started, the temperature of the cooling roller gradually increases due to an increase in temperature inside the apparatus resulting from the heat emitted from the fixing device 100 and the absorption of heat of the sheet P transmitted from the fixing device 100. Then, when the temperature of the cooling roller increases up to the melt temperature of the phase-change material 202, the phase-change material starts to be melted and changes from solid into liquid. Since latent heat is absorbed during this process, the temperature of the phase-change material is maintained to be approximately constant. Therefore, the temperature of the cooling roller 201 is also maintained to be approximately constant.

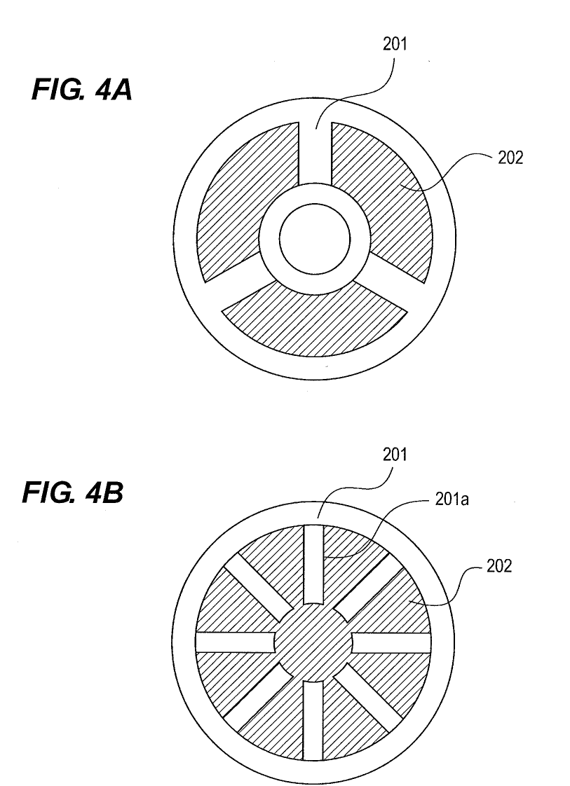

Furthermore, for example, as illustrated in FIG. 4A, the cross-section of the cooling roller 201 may be formed as a three-arrow-shaped hollow pipe. Further, as illustrated in FIG. 4B, a plurality of plate-shaped ribs 201a may be provided inside the cooling roller 201 so as to project from the inner peripheral surface thereof and extend in an axial direction. Then, when the ribs 201a and the like are provided in this manner, the contact area between the cooling roller 201 and the phase-change material 202 increases, resulting in an improvement in the heat exchange efficiency. Even in this configuration, the roller may be formed of a drawing material and be realized at low cost.

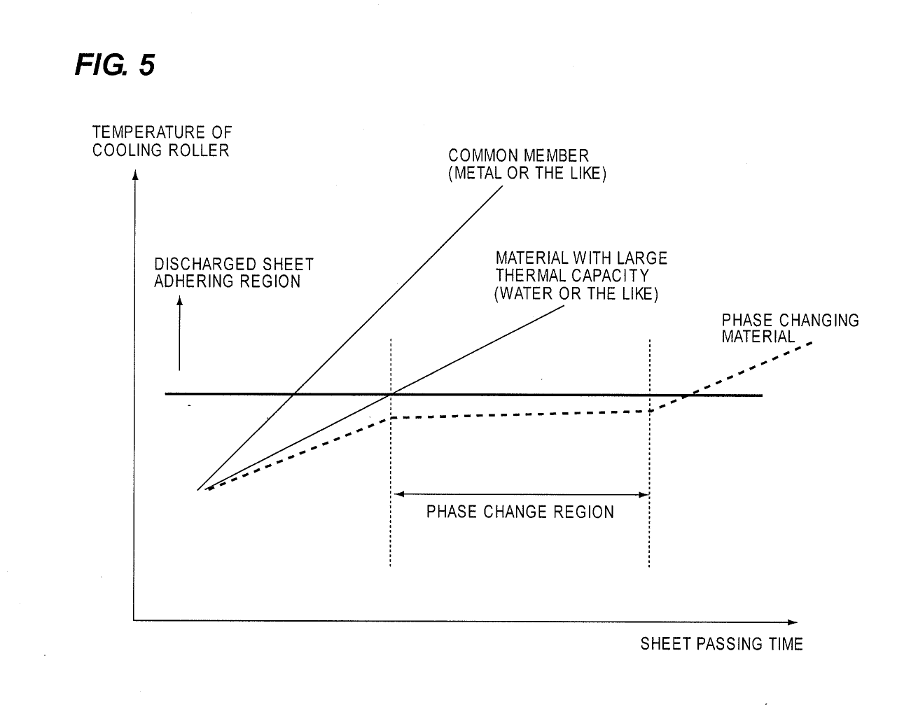

FIG. 5 is a diagram illustrating a change in temperature of a cooling roller encapsulating a phase-change material as in the embodiment, a solid metallic roller, and a roller encapsulating a material with a high thermal capacity (for example, water). As illustrated in FIG. 5, when the phase-change material is encapsulated, it is possible to suppress an increase in temperature of the cooling roller for a long period of time as much as the latent heat generated by a phase-change is absorbed.

Furthermore, the time for suppressing an increase in temperature depends on the amount of the phase-change material 202. For example, in the cooling roller with a diameter of about 20 mm and a width of about 340 mm, about 100 g of the phase-change material may be encapsulated therein. In this case, the phase-change temperature is sustained for about 2.5 hours. Since the time for the continuous operation (continuous sheet passing operation) performed by the user is different according to the specification of the apparatus, the diameter of the cooling roller may be increased according to the specification so as to increase the amount of the phase-change material.

On the other hand, when the continuous operation is ended and the apparatus becomes a standby state, the temperature of the cooling roller decreases and the phase-change material 202 is solidified. Since the latent heat is discharged at the time of the solidification, it is possible to maintain the temperature of the member coming into contact with the sheet, the member corresponding to the cooling roller or a guide member upstream or downstream in the sheet conveying direction. Accordingly, it is possible to reduce a change in temperature of the sheet at the next copy operation.

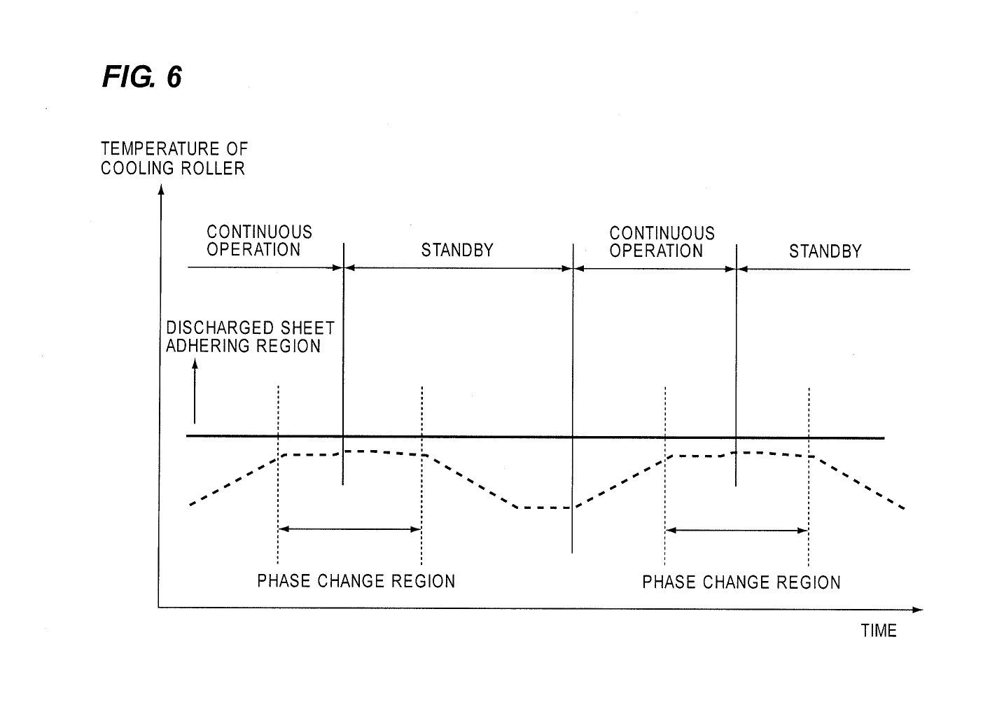

Further, as illustrated in FIG. 6, the cooling roller 201 with such a configuration may obtain the same effect over and over since the phase-change between solid and liquid of the phase-change material 202 is repeated during the continuous operation. Furthermore, since the phase-change material 202 is efficiently solidified by the more number of contacts with the roller in the standby state after the continuous operation is ended, the phase-change material may be circulated and stirred by idly rotating the cooling roller 201 for a predetermined time.

As described above, even if the sheet heated after the fixing is continuously conveyed, the phase-change of the phase-change material 202, encapsulated in the cooling roller, is performed by the heat from the sheet, so that the temperature of the cooling roller 201 may be maintained to be constant. Accordingly, even when the temperature of the cooling roller increases due to the continuous operation, the cooling ability of the cooling roller 201 may be maintained for a long period of time, and the temperature of the discharged sheet may be maintained at a constant temperature or less for a long period of time. That is, it is possible to efficiently cool the hot sheet heated by heat-fixing without causing power consumption or noise by encapsulating the phase-change material 202 in the cooling roller 201.

Further, since the phase-change material absorbs heat, a fan provided outside the cooling roller 201 to cool the cooling roller is not needed, and the sheet may be cooled at low noise without consuming power. Furthermore, since the phase-change material is not made of a special material but made of the mixture of common materials, the phase-change material is cheaper than the heat pipe or the like. Furthermore, since the phase-change temperature may be arbitrarily determined to a certain degree by the combination of the materials, it is possible to handle various conditions such as a fixing condition, toner, and a conveying path.

Incidentally, in an apparatus performing an operation in which a continuous operation is performed for a pretty long time or a continuous operation is repeated at short intervals, the phase-change material inside the cooling roller may be completely melted. In this case, the cooling roller (the phase-change material) is cooled by using the fan.

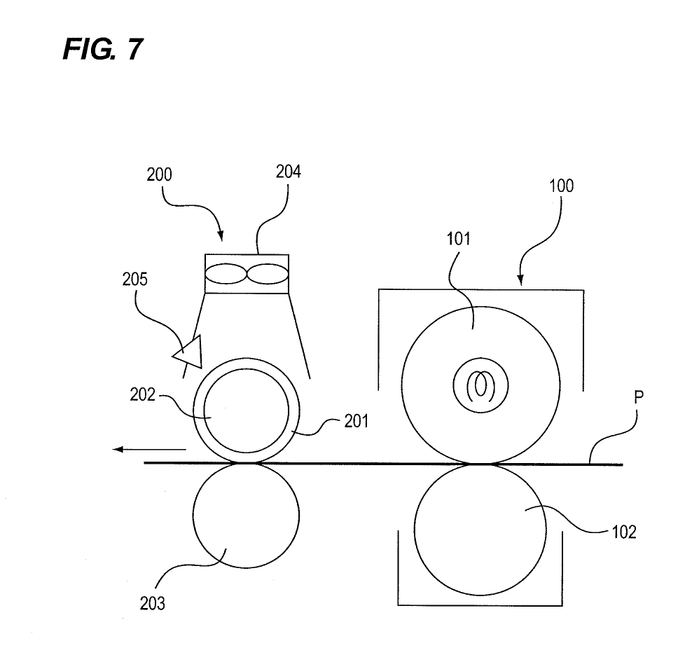

FIG. 7 is a diagram illustrating a configuration of the pair of cooling rollers of the image forming apparatus using such a fan according to the second embodiment of the invention. Furthermore, in FIG. 7, the same reference numerals as those of FIG. 2 respectively indicate the same or corresponding components.

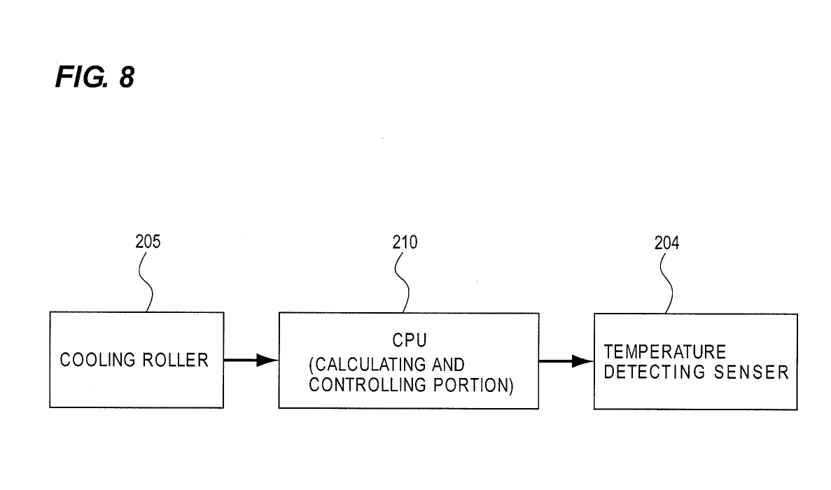

In FIG. 7, a cooling fan 204 is provided as a fan cooling the cooling roller 201, and a temperature detecting sensor 205 is provided as a temperature detecting portion detecting the temperature of the cooling roller 201. As illustrated in FIG. 8, temperature information obtained from the temperature detecting sensor 205 is input to the CPU (the calculating and controlling portion) 210 as a controlling portion provided at a predetermined position of the apparatus body 1A. Then, the CPU 210 driving the cooling fan 204 drives the cooling fan 204 based on a detection signal from the temperature detecting sensor 205, and the cooling roller 201 is cooled by the air blown from the cooling fan 204.

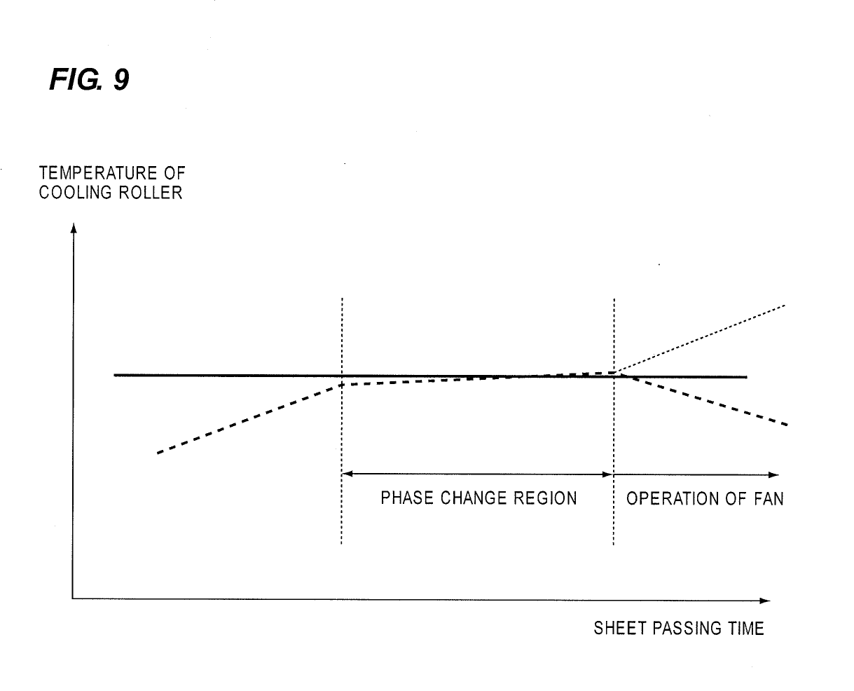

FIG. 9 is a diagram illustrating a relation between the sheet passing time and the temperature of the cooling roller. For example, when the apparatus is continuously operated for a long period of time and the phase-change material inside the cooling roller 201 is completely melted to change into liquid, the phase-change material may not absorb latent heat, so that the temperature starts to increase again.

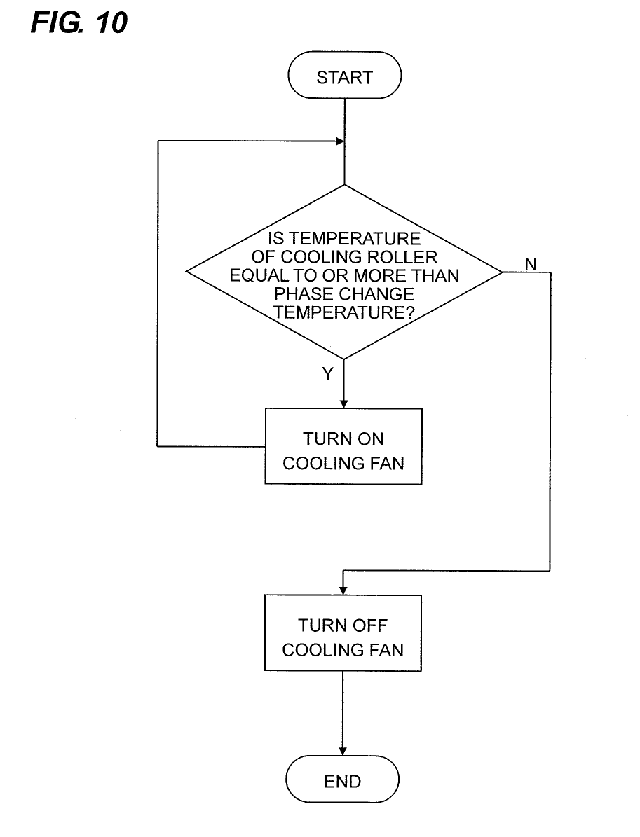

Here, as illustrated in FIG. 10, the CPU 210 detects whether the temperature of the cooling roller 201 increases up to the phase-change temperature or more of the phase-change material 202 using the temperature detecting sensor 205. Then, when it is detected that the temperature of the cooling roller becomes the phase-change temperature or more (Y of S100), the cooling fan 204 is turned on (S101). That is, when it is determined that the phase-change material is completely melted and changes into liquid, the operation of the cooling fan 204 is started.

Then, when the cooling fan 204 is operated in this manner, the cooling roller 201 is cooled by the air blown from the cooling fan 204, and the phase-change material 202 therein starts to be solidified again. When the temperature detecting sensor 205 detects that the phase-change material 202 is completely solidified and the temperature of the cooling roller becomes less than the phase-change temperature (N of S100), the cooling fan is turned off to stop the blowing air (S102).

As described above, in the embodiment, the cooling fan 204 is driven according to the temperature of the cooling roller detected by the temperature detecting sensor 205. Accordingly, even when the phase-change material is completely melted after the apparatus is operated for a pretty long time or the continuous operation is performed at short intervals and the next continuous operation is performed while the phase-change material is not sufficiently solidified, the temperature of the sheet may be suppressed to be a desired temperature or less. Furthermore, in the embodiment, the use of the cooling fan 204 is limited, and power consumption becomes much smaller than that of the case of using the cooling fan 204 all the time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-191250, filed Aug. 27, 2010, which is hereby incorporated by reference herein in its entirety.

What is claimed is:

1. An image forming apparatus comprising:
a fixing portion that fixes a toner image on a sheet by heat;
a cooling roller that is provided downstream of the fixing portion in a sheet conveying direction and cools the sheet conveyed from the fixing portion; and
a phase-change material that is encapsulated in the cooling roller and has a phase-change temperature to cause a phase-change between solid and liquid being higher than a temperature inside the apparatus in a standby state, and being lower than a glass transition temperature of the toner on the sheet.

2. The image forming apparatus according to claim 1,
wherein a plurality of plate-shaped ribs is provided inside the cooling roller so as to project from an inner peripheral surface of the cooling roller and extend in an axial direction.

3. The image forming apparatus according to claim 1, further comprising:
a temperature detecting portion that detects a temperature of the cooling roller;
a fan that cools the cooling roller; and
a controlling portion that drives the fan based on a detection signal from the temperature detecting portion so that the fan is driven until the temperature of the cooling roller becomes less than the phase-change temperature when it is determined that the temperature of the cooling roller becomes more than the phase-change temperature.
